(19) United States
(12) Patent Application Publication
(10) Pub. No.: US 2011/0306451 A1
(43) Pub. Date: Dec. 15, 2011

(54) DRILL PRESSES HAVING SPRING-LOADED DRIVE BELT TENSIONERS

(75) Inventor: Sarah Jane Montplaisir, Joppa, MD (US)

(73) Assignee: Black & Decker Inc., Newark, DE (US)

(21) Appl. No.: 12/813,554

(22) Filed: Jun. 11, 2010

(51) Int. Cl. F16H 7/12

(52) U.S. Cl. 474/135

(57) ABSTRACT

A drill press includes a motor having a rotatable shaft and a stepped motor pulley mounted on the rotatable shaft, a rotatable spindle and a stepped spindle pulley mounted on the rotatable spindle, and a stepped center pulley located between the motor pulley and the spindle pulley. A first drive belt connects the center pulley with the motor pulley, and a second drive belt connects the spindle pulley with the center pulley. A spring-loaded drive belt tensioner applies tension to the first drive belt. The belt tensioner has a first position for applying a first level of tension to the first drive belt and a second position for applying a second level of tension to said first drive belt that is less than the first tension level. When the belt tensioner is in the second position, the positions of the belts on the stepped pulleys are changeable.

### BACKGROUND OF THE INVENTION

1. Field of the Invention

The present invention is generally related to power equipment, and more specifically related to power equipment having drive belt systems such as drill presses.

2. Description of the Related Art

Drill presses typically include a base, a vertical support column extending upwardly from the base, a table attached to a mid-section of the support column for holding work pieces, and a head stock secured to an upper end of the support column. The head stock contains a motor that is coupled with a rotatable spindle via one or more drive belts that transmit power from the motor to the spindle. The head stock includes a handle that is turned for moving the spindle downward toward the table, along a vertical axis that is parallel with the longitudinal axis of the support column. The height of the table may be adjusted using a second rotatable handle coupled with a rack and pinion system. The table may be rotated about the longitudinal axis of the support column to offset the table from the axis of the spindle. In some designs, a drill chuck for holding a drill bit is connected to a lower end of the spindle. The drill chuck may have three jaws that hold an upper end of the drill bit in the chuck. Some drill presses include a spindle having a tapered opening at a lower end thereof for receiving a drill bit having a tapered shaft that fits into the tapered opening. When the drill press is activated, the motor rotates the spindle about a vertical axis via the one or more drive belts, which, in turn, rotate the drill bit.

Drill presses provide many advantages over hand-held drills. First, the spindle is moved by a lever working on a rack and pinion system, which gives an operator considerable mechanical advantage. Thus, less effort is required to advance the drill bit through a work piece. Second, a drill press has a table for supporting a work piece, which enables a vice grip or clamp to be used to hold the work piece in an immovable position on the table. In addition, the spindle moves along a fixed vertical axis relative to the top surface of the table, which allows operators to drill holes in work pieces with great accuracy.

Many drill presses have a mechanism for changing the speed of rotation of the drill. Often, the speed is changed by manually moving one or more drive belts across a stepped pulley arrangement. In one design, in order to change the speed, an operator must first move the motor to make sufficient slack in at least one of the drive belts. After the drive belts are repositioned, the motor is moved back to its initial position for tensioning the drive belts. Moving the motor requires that the motor be mounted in such a way that it may be translated to allow for belt tensioning. This mounting arrangement may cause unwanted noise and vibration if the machining of the drill press is not precise.

Recently, some drill presses have added a third stepped pulley to increase the possible range of speed changes. Some drill presses are equipped with a variable speed motor or a continuously variable transmission, which enable operators to change speed while the machine is running.

There have been a number of developments related to speed changing devices for power equipment. For example, U.S. Pat. No. 4,340,377 to Johnson et al. discloses a drill press having stationary pulleys with stepped diameter portions that form a variable speed drive between a motor coupled with one stepped pulley and a driven device coupled with a second stepped pulley, such as a spindle pulley. The system includes a belt tensioner that is moved out of contact with an inner surface of a drive belt when it is desirable to change the speed of the drill, and is moved back into contact with the inner surface of the drive belt after the speed has been changed for re-tensioning the drive belt.

In spite of the above advances, there remains a need for a tensioner for a drive belt system for power equipment, such as a drill press, that increases the amount of contact between the belts and the pulleys, and which increases the amount of power transmitted between the motor and the spindle. The also remains a need for a step pulley system for power equipment such as a drill press that provides for a greater range of speeds. In addition, there remains a need for a drive system for a drill press whereby the motor is rigidly mounted so that the speed of the drill may be changed without moving the motor. There also remains a need for a drive system for power equipment having a tensioner that automatically and consistently applies a proper level of tension to the drive belts to minimize the chance of operator error in applying too little or too much tension. There also remains a need for a drive system for power equipment having a belt tensioner that continuously takes up slack in a drive belt during operation, even in instances where the drive belt stretches and wears during use.

### SUMMARY OF THE INVENTION

In one embodiment, a drill press preferably includes a motor having a rotatable motor shaft, a motor pulley mounted on the rotatable motor shaft, a rotatable spindle, and a spindle pulley mounted on the rotatable spindle. The drill press desirably includes at least one drive belt coupling the motor pulley with the spindle pulley for selectively rotating the rotatable spindle when operating the motor. In one embodiment, a spring-loaded drive belt tensioner is preferably adapted to selectively apply a predetermined tension level to at least one drive belt. The spring-loaded drive belt tensioner preferably has a first position for applying a first level of tension to the at least one drive belt and a second position for applying a second level of tension to the at least one drive belt that is lower than the first level of tension.

In one embodiment, the motor pulley is desirably a stepped motor pulley having a plurality of steps of varying radii and the spindle pulley is a stepped spindle pulley having a plurality of steps of varying radii. As a result, the speed of the drill may be modified by changing the position of one or more drive belts. In one embodiment, the position of the at least one drive belt relative to the plurality of steps on the stepped pulleys is changeable for varying the speed of the drill press when the spring-loaded drive belt tensioner is in the second position. In one embodiment, the spring-loaded drive belt tensioner is extended when in the first position and retracted when in the second position. In one embodiment, the drill press preferably includes a lock engageable with the spring-loaded drive belt tensioner for holding the spring-loaded drive belt tensioner in the second, retracted position. In one embodiment, the lock may be disengaged from the drive belt tensioner for enabling the belt tensioner to re-engage the drive belt for re-applying tension to the drive belt.

In one embodiment, the at least one drive belt preferably has an inner surface that is adapted to engage the pulleys and an outer surface that faces away from the inner surface. In one embodiment, the spring-loaded drive belt tensioner desirably engages the outer surface of the at least one drive belt when in the first position for applying the first level of tension to the at least one drive belt. In one embodiment, the first level of tension applied by the belt tensioner is preferably between about 4-10 lbs. of tension. The second level of tension applied by the belt tensioner is preferably lower than the first level of tension. In one embodiment, the second level of tension is about 0-3 lbs. of tension. In one embodiment, the belt tensioner applies no tension to the drive belts when in the second position.

In one embodiment, the drill press desirably includes a center pulley located between the motor pulley and the spindle pulley. The at least one drive belt preferably includes a first drive belt coupling the motor pulley with the center pulley and a second drive belt coupling the center pulley with the spindle pulley. In one embodiment, the motor pulley desirably rotates the center pulley through the first drive belt and the center pulley desirably rotates the spindle pulley through the second drive belt.

In one preferred embodiment, when in the first position, the spring-loaded drive belt tensioner is preferably adapted to engage a slack side of the first drive belt for applying the first level of tension to the first drive belt. In a preferred embodiment, when in the first position, the spring-loaded drive belt tensioner is preferably adapted to apply tension to an outer surface and a slack side of a first drive belt that connects the motor pulley and the center pulley. In another embodiment, the belt tensioner may engage a drive belt extending between the center pulley and the spindle pulley.

In one embodiment, a drill press preferably includes a motor having a rotatable motor shaft and a stepped motor pulley mounted on the rotatable motor shaft, a rotatable spindle and a stepped spindle pulley mounted on the rotatable spindle, and a stepped center pulley located between the stepped motor pulley and the stepped spindle pulley. The drill press desirably includes a first drive belt connecting the stepped center pulley with the stepped motor pulley, and a second drive belt connecting the stepped spindle pulley with the stepped center pulley. The drill press preferably includes a spring-loaded drive belt tensioner adapted to apply tension to the first drive belt. The spring-loaded drive belt tensioner desirably has a first position for applying a first level of tension to the first drive belt and a second position for applying a second level of tension to the first drive belt that is less than the first level of tension. In one embodiment, the belt tensioner may selectively apply tension to the second drive belt.

In one embodiment, the first drive belt preferably has an inner surface adapted to engage the stepped motor pulley and the stepped center pulley, and the first drive belt desirably has an outer surface facing away from the inner surface. In one embodiment, the spring-loaded drive belt tensioner preferably selectively engages the outer surface of the first drive belt when applying the first level of tension. In one embodiment, the spring-loaded drive belt tensioner desirably selectively engages a slack side of the first drive belt when applying the first level of tension.

In one embodiment, each of the stepped pulleys preferably has a plurality of steps of varying radii. The positions of the first and second drive belts relative to the plurality of steps of the stepped pulleys are preferably changeable for varying the speed of the drill press when the spring-loaded drive belt tensioner is in the second position.

In one embodiment, the spring-loaded drive belt tensioner preferably includes a swing arm having a first end pivotally connected to the head stock, either directly or indirectly through a plate, and a second, free end adapted to swing about the first end. The spring-loaded tensioner preferably includes a freely rotating spool mounted to and projecting upwardly or downwardly from the second, free end of the swing arm, and a spring in contact with the swing arm for providing a spring force for normally urging the freely rotating spool against the first drive belt when the spring-loaded drive belt tensioner is in the first position. In one embodiment, the spring preferably urges the spool against an outer surface of the first drive belt when the belt tensioner is in the first position. In one embodiment, the spring preferably urges the spool against the slack side of the first drive belt when the belt tensioner is in the first position. In one embodiment, the drill press preferably includes a locking element engageable with the swing arm for holding the spring-loaded drive belt tensioner in the second position and overcoming the spring force, whereby no or minimal tension is applied to the drive belt.

In one embodiment, each of the drive belts preferably has an inner surface including a plurality of grooves and the stepped pulleys have a plurality of steps, each having a plurality of projections adapted to mesh with the plurality of grooves on the inner surface of the drive belts. In one embodiment, the drive belts have a V-shaped cross section adapted to seat within v-shaped grooves provided on the steps of the pulleys for seating the belts in the pulleys.

In one embodiment, a variable speed drill press having a spring-loaded drive belt tensioner preferably includes a base, a support column projecting upwardly from the base along a vertical axis, a table connected with the support column, and a head stock mounted to an upper end of the support column. The drill press desirably includes a motor rigidly mounted to the head stock, the motor having a rotatable motor shaft and a stepped motor pulley mounted on the rotatable motor shaft, a rotatable spindle mounted on the head stock for rotating about an axis that is parallel to the vertical axis of the support column, a stepped spindle pulley connected to the rotatable spindle, and a stepped center pulley mounted on the head stock and located between the stepped motor pulley and the stepped spindle pulley. The drill press preferably includes a first drive belt connecting the stepped center pulley with the stepped motor pulley, and a second drive belt connecting the stepped spindle pulley with the stepped center pulley. The drill press desirably includes a spring-loaded drive belt tensioner adapted to apply tension to an outer surface of the first drive belt on a slack side of the first drive belt. The spring-loaded drive belt tensioner preferably has a first position for applying a first level of tension to the first drive belt and a second position for applying a second level of tension to the first drive belt that is less than the first level of tension. The positions of the first and second drive belts relative to the plurality of steps of the stepped pulleys may be changed for varying the speed of the drill press, preferably when the spring-loaded drive belt tensioner is in the second position.

In one embodiment, a drill press includes a step pulley arrangement having a spring-loaded tensioner. Using a spring-loaded tensioner for the drive belts enables the motor to be rigidly mounted, thereby reducing the number of parts, as well as extra machining on the main head casting. In addition, proper belt tension will preferably be maintained at all times, eliminating user error.

In one embodiment, the spring-loaded drive belt tensioner preferably includes an arm that is mounted to a base of the head stock on a pivot. In one embodiment, the arm is preferably spring loaded via either a clock spring or a torsion spring such that it wants to provide a force in the direction of the belts. A free-swinging end of the arm desirably includes a mandrel or rotatable spool mounted to a shaft and supported by bearings. The mandrel or rotatable spool desirably contacts the belts. The bearings associated with the rotatable spool preferably enable the spool to freely spin with the belts.

In one embodiment, the mandrel or spool is mounted so that it engages the belts on the slack side of the belt and contacts the belt on the outside. This will allow the spool to work with both poly-v and regular section belts. The mandrel is preferably tall enough to contact the belt in all possible pulley positions and combinations.

In one embodiment, in order to change speeds, the spring-loaded tensioner may include a lock to hold it in a retracted position. In one embodiment, an operator will pull the spring-loaded tensioner away from the belts so that the spool releases tension on the belts and sets a locking device. With the spring-loaded tensioner in the retracted position, there is sufficient slack in the drive belts to change speeds. Once the belts are in a position for a desired speed, the lock may be released and the tensioner may be moved back into position so that the mandrel engages the belts for applying tension.

Although the present invention is not limited by any particular theory of operation, it is believed that spring-loaded belt tensioners have never been used for a stepped pulley drive system having a plurality of different belt positions. In one embodiment, providing a step pulley drill press having a spring-loaded drive belt tensioner will enable proper belt tension to be maintained at all times. In one embodiment, when the belts stretch or wear, the spring-loaded tensioner will automatically adjust to provide a proper level of belt tension. In addition, providing a spring-loaded tensioner for the belts will use less machining on the casting, less moving parts, and result in less vibration due to using a rigidly mounted motor.

These and other preferred embodiments of the present invention will be described in more detail below.

### BRIEF DESCRIPTION OF THE DRAWING

FIG. 1 shows a perspective view of a drill press, in accordance with one embodiment of the present invention.

FIG. 2 shows a top perspective view of the drill press shown in FIG. 1 including stepped pulleys, drive belts, and a spring-loaded drive belt tensioner, in accordance with one embodiment of the present invention.

FIG. 3 shows the stepped pulleys of FIG. 2 and the proper placement of the drive belts for setting different drill speeds, in accordance with one embodiment of the present invention.

FIG. 4 shows a perspective view of the stepped pulleys, drive belts, and spring-loaded drive belt tensioner shown in FIG. 2.

FIG. 5 shows a cross-sectional view of the spring-loaded drive belt tensioner shown in FIGS. 2 and 4.

FIG. 6 shows a side view of the stepped pulleys, drive belts, and a spring-loaded drive belt tensioner drive shown in FIG. 2.

FIGS. 7A-7C show a method of releasing tension on a drive belt for changing the drill speed, in accordance with one embodiment of the present invention.

FIGS. 8A and 8B show the drill press of FIG. 2 with the spring-loaded drive belt tensioner rotated away from one of the drive belts for reducing the tension level for changing the position of the belts, in accordance with one embodiment of the present invention.

FIG. 9 shows two drive belts meshing with a center spindle of a drill press drive system, in accordance with one embodiment of the present invention.

FIG. 10 shows a method of measuring the level of tension applied by a spring-loaded drive belt tensioner, in accordance with one embodiment of the present invention.

### DETAILED DESCRIPTION

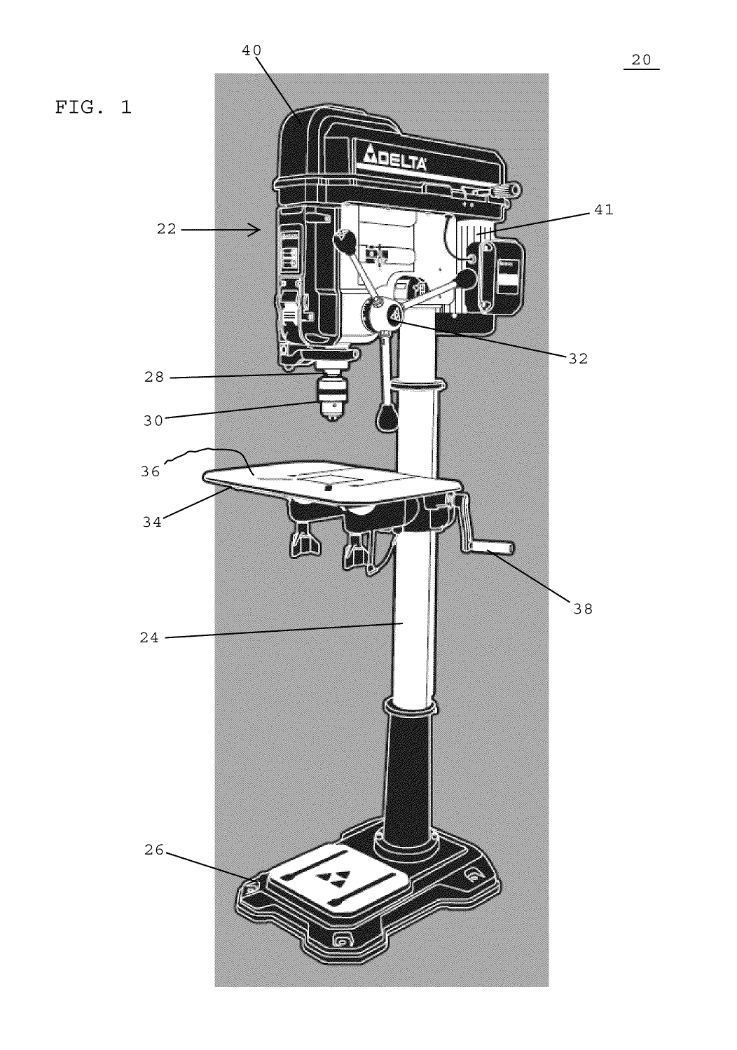

Referring to FIG. 1, in one embodiment, a drill press 20 preferably includes a head stock 22 supported atop a vertically-extending support column 24 and a base 26 supporting a lower end of the support column. The drill press 20 desirably includes a rotatable spindle 28 projecting from a lower end of the head stock 22 and a chuck 30 mounted to a lower end of the spindle. The chuck 30 is preferably adapted to receive a drill bit (not shown). The drill press desirably includes a rotatable handle 32 that may be engaged for lowering the rotatable spindle 28 and the chuck 30 along a vertical axis that is parallel with the longitudinal axis of the support column 24. The drill press 20 also preferably includes a table 34 having a top surface 36 adapted to support a work piece below the spindle 28 and the chuck 30. The drill press 20 preferably includes a table handle 38 that may be operated for raising and lowering the table 34 using a rack and pinion arrangement.

The head stock 22 preferably includes a head stock pulley cover 40 that contains a drive system for supplying power to the spindle 28. In one embodiment, the drive system preferably includes a motor 41 that is coupled with the spindle 28 via stepped pulleys and drive belts, as will be described in more detail below. The head stock cover 40 is desirably moveable between the closed position shown in FIG. 1 and an open position for accessing the drive belts and rotatable pulleys located between the motor and the spindle 28. In one embodiment, the position of the drive belts on the pulleys may be changed for modifying the speed of the drill press.

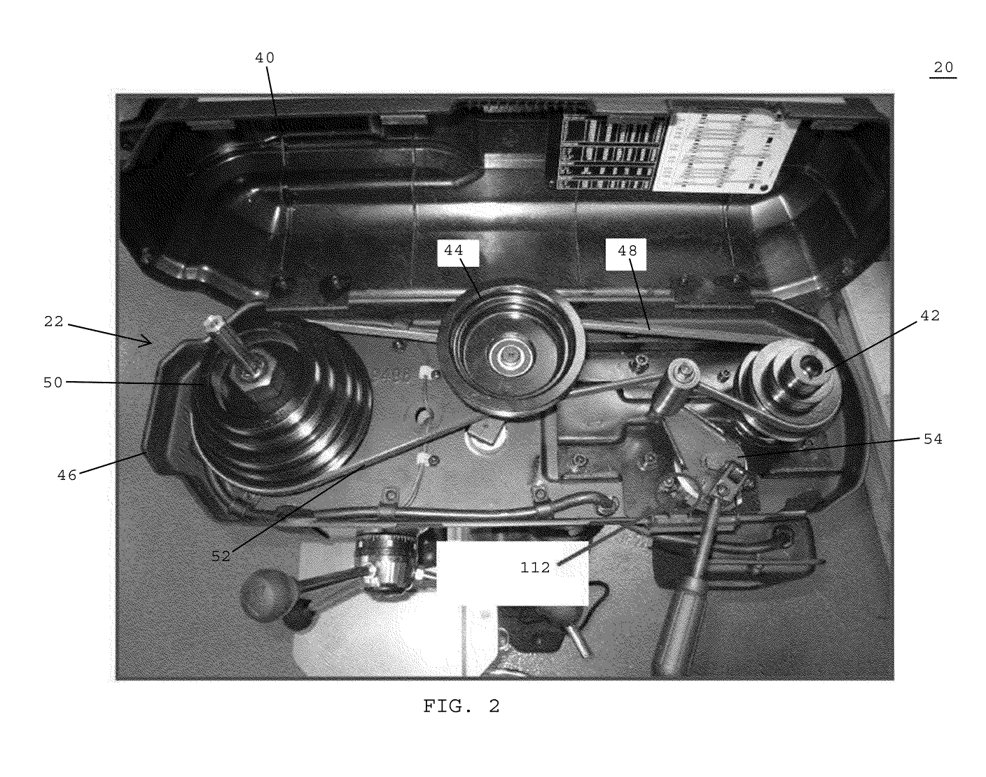

Referring to FIG. 2, in one embodiment, the cover 40 of the head stock 22 may be opened for exposing the drive system. In one embodiment, the drive system preferably includes a stepped motor pulley 42 that is rotated by a motor shaft coupled with a motor (not shown). The drive system preferably includes a stepped center pulley 44 that is directly mounted to the head stock 22 via a pivoting arm 45. In one embodiment, the pivoting arm 45 preferably enables the position of the stepped center pulley 44 to be shifted for changing the belt positions on the stepped pulleys of the drive system. The stepped center pulley 44 is preferably freely rotatable relative to the head stock 22.

The drive system preferably includes a first drive belt 48 that extends about the motor pulley 42 and the center pulley 44. In one embodiment, the first drive belt 48 is preferably adapted to transmit power from the motor pulley 42 to the center pulley 44. In one embodiment, the first drive belt 48 is preferably a poly-v drive belt with v-shaped grooves formed on an inner face thereof, and the stepped pulleys have v-shaped grooves or projections adapted to mesh with the v-shaped grooves on the drive belts. In another embodiment, the drive belts may be conventional drive belts having a smooth inner face and the pulleys may have smooth stepped surfaces that mesh with the smooth inner faces of the drive belts. In other embodiments, any type of drive belt well known to those skilled in the art may be used.

In one embodiment, the drive system preferably includes a stepped spindle pulley 50 that is coupled with the spindle 28 shown in FIG. 2. The drive system preferably includes a second drive belt 52 that interconnects the freely rotating center pulley 44 with the spindle pulley 50.

In one embodiment, the drill press 20 preferably includes a spring-loaded drive belt tensioner 54 that is adapted to apply tension to an outer surface or face of one of the drive belts. In one embodiment, the spring loaded tensioner desirably applies tension to the outer face of the first drive belt 48. As will be described in more detail herein, the spring-loaded tensioner 54 uses spring force for automatically and continuously applying tension to the slack side and/or outer surface of the first drive belt 48 to maintain optimum tension on the first drive belt 48. As such, the motor associated with the motor pulley 42 may be rigidly mounted to the drill press 20, thereby eliminating several parts previously required for shifting the position of the motor for changing speeds, as well as the previously required extra machining on the main head stock casting. Other benefits desirably include that proper belt tension will always be maintained on the drive belts, thereby eliminating user error when attempting to set the tension on the drive belts.

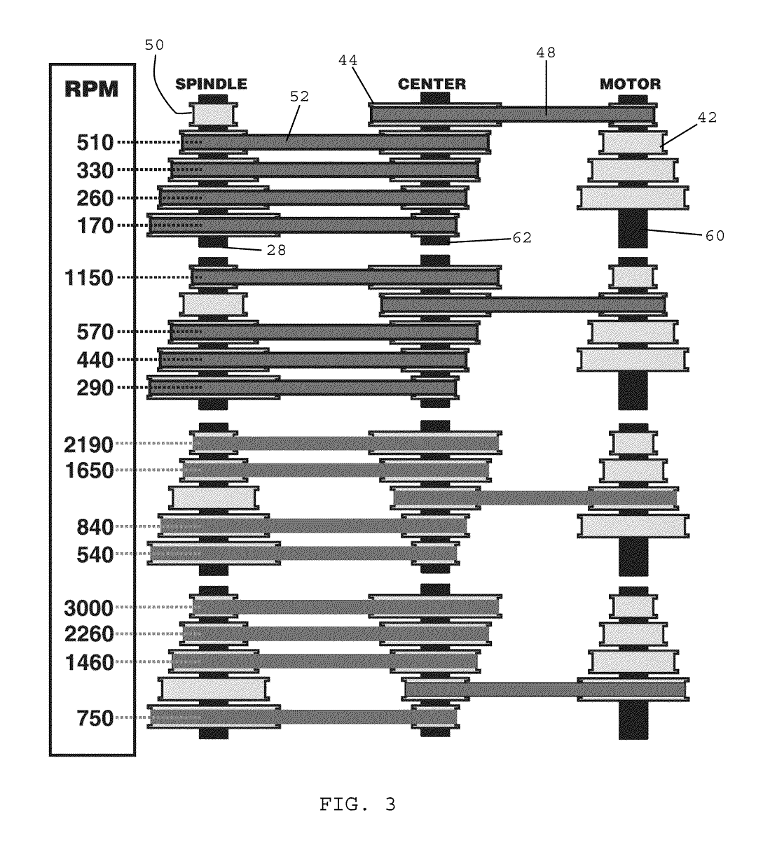

Referring to FIG. 3, in one embodiment, the drive system preferably includes the stepped motor pulley 42, the freely rotating stepped center pulley 44, and the stepped spindle pulley 50. The drive system preferably includes a rotatable motor shaft 60 that is rotated by the motor (not shown). As the motor shaft 60 rotates, it rotates the motor pulley 42. In one embodiment, the motor pulley 42 is a stepped pulley having four different steps of varying radii that enable the drill speed to be changed.

In one embodiment, the center pulley 44 is rotatably mounted on a center pulley shaft 62. A lower end of the center pulley shaft 62 is preferably mounted to the head stock 22 via a pivoting arm 45 that desirably enables the position of the center pulley to be selectively shifted for changing the positions of the drive belts. In one embodiment, the center pulley 44 is a stepped pulley having five steps of varying radii. The first drive belt 48 interconnects the motor pulley 42 with the center pulley 44. The first drive belt 48 may have v-shaped grooves formed on an inner surface thereof that desirably mesh with v-shaped radial projections on the respective motor pulley and center pulley.

In one embodiment, the drive system also preferably includes the spindle pulley 50 having a plurality of steps of varying radii. The spindle pulley 50 is desirably mounted to an upper end of the rotatable spindle 28 so that rotation of the spindle pulley 50 results in simultaneous rotation of the spindle 28, which, in turn, rotates a drill mounted on the lower end of the spindle. The second drive belt 52 preferably couples the center pulley 44 with the spindle pulley 50.

In one embodiment, the motor shaft 60 rotates the motor pulley 42 for driving the first drive belt 48. In turn, the first drive belt 48 rotates the center pulley 44 about the center pulley shaft 62. As the center pulley 44 rotates, the center pulley drives the second drive belt 52, which, in turn, rotates the spindle pulley 50. Rotation of the spindle pulley 50 simultaneously rotates the spindle 28, and the chuck 30 (FIG. 1) and drill bit (not shown) secured to the chuck.

FIG. 3 shows the various positions that the first and second drive belts 48, 52 may be placed relative to the steps on the motor pulley 42, the center pulley 44, and the spindle pulley 50, in accordance with one embodiment. As shown in FIG. 3, changing the positions of the drive belts 48, 52 enables up to 16 different spindle speeds to be established for the drill press. For purposes of illustration, FIG. 3 shows the four different positions of the first drive belt 48, and the four different positions of the second drive belt 52 for each of the first drive belt positions. As such, FIG. 3 shows the 16 different combinations of positions for the first and second drive belts. In actual operation, however, there is preferably only one first drive belt extending about the motor pulley and center pulley, and only one second drive belt extending about the center pulley and the spindle pulley.

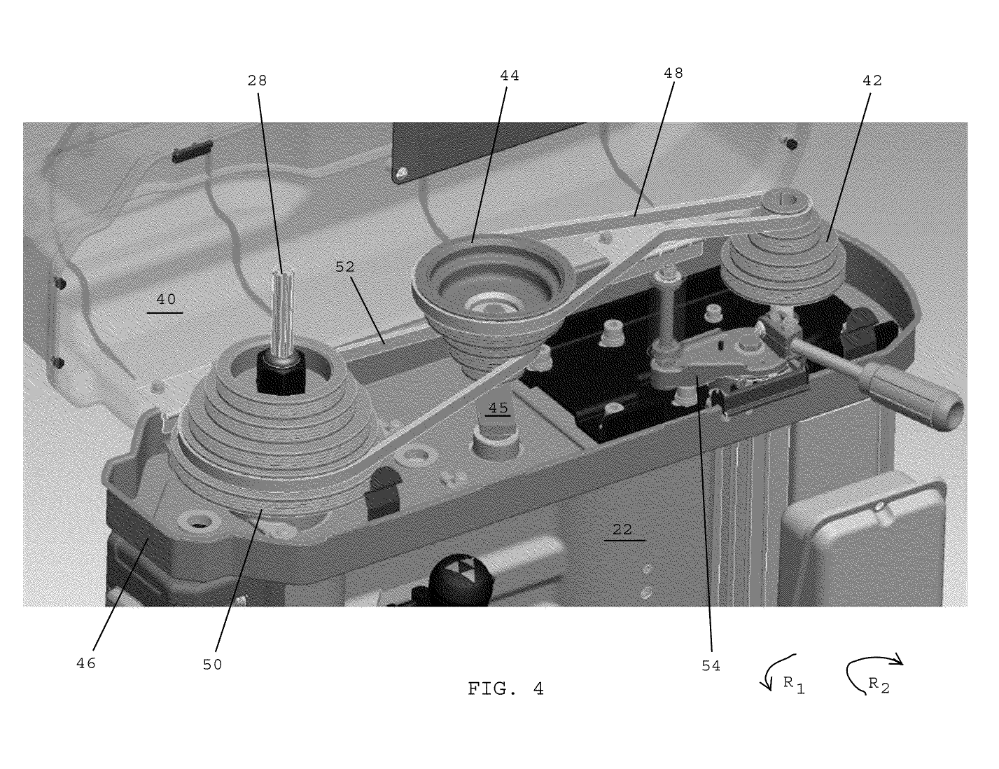

Referring to FIG. 4, in one embodiment, the drive system is preferably positioned atop the base 46 of the head stock. In one embodiment, the motor (not shown) rotates the motor pulley 42, which, in turn, rotates the center pulley 44 via the first drive belt 48. As the center pulley 44 rotates, the second drive belt 52 rotates the spindle pulley 50 for rotating the spindle 28. As noted above, the exact position of the first drive belt 48 and the second drive belt 52 on the stepped pulleys may be adjusted for changing the speed of rotation of the spindle 28.

In one embodiment, the spring-loaded tensioner 54 applies a tensioning force to the outer surface of the first drive belt 48. The tensioner also preferably applies tension to the slack side of the first drive belt. In one embodiment, the spring-loaded tensioner 54 may be rotated in a counter-clockwise direction designated R₁ for lessening the amount of tension applied by the tensioner 54 to the first drive belt 48 so that the position of the first and second drive belts 48, 52 may be changed for modifying the speed of the drill press. In one embodiment, zero tension is applied to the first drive belt when the tensioner is retracted. After the position of the first and second drive belts has been modified for changing the speed, the spring-loaded tensioner 54 may be rotated in clockwise direction designated R₂ so that the belt tensioner 54 re-engages the first drive belt 48 for applying tension to the drive system. The tensioner preferably includes a spring that normally urges the tensioner to rotate in the direction R₂.

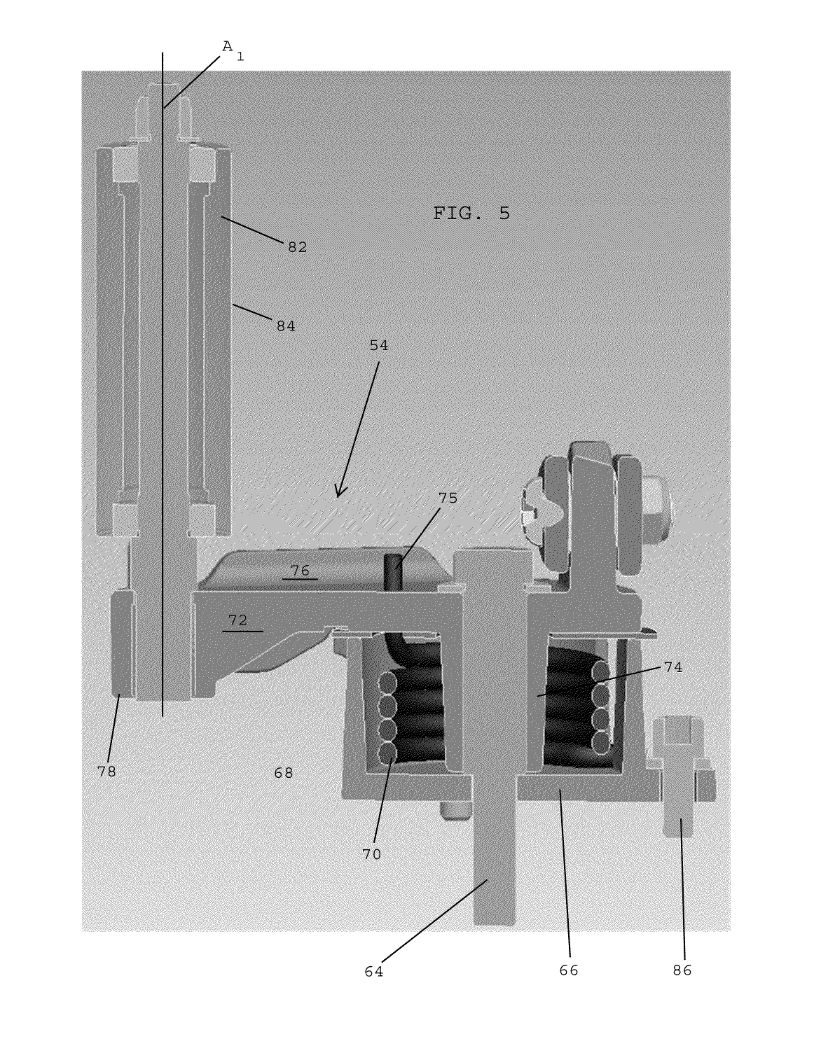

Referring to FIG. 5, in one embodiment, the spring-loaded tensioner 54 is preferably adapted to apply a continuous tensioning force onto an outer surface of a drive belt for automatically and continuously applying a proper level of tension to the drive belt. In one embodiment, the spring-loaded tensioner 54 preferably includes a tensioner shaft 64 having a lower end secured to the head stock 22 (FIG. 4). The spring-loaded tensioner 54 desirably includes a base 66 having a well 68 adapted to receive a spring 70. The spring-loaded tensioner 54 preferably includes a rotatable arm 72 having a tubular projection 74 that receives an outer surface of the tensioner shaft 64 so that the rotatable arm 72 may rotate in counter-clockwise and clockwise directions about the shaft. The rotatable arm 72 preferably includes a rib 76 that strengthens the rotatable arm 72. In one embodiment, the spring preferably includes at least one part that is coupled with the arm for transferring spring force to the rotatable arm 72. In one embodiment, the spring 70 preferably has an extension 75 that passes through an opening in the rotatable arm 72 for connecting the spring with the arm for transmitting spring force from the spring to the arm.

In one embodiment, the rotatable arm 72 preferably includes a free end 78 adapted to receive a tensioner spool shaft 80, which, in turn, has a tensioner spool 82 mounted thereon. The tensioner spool 82 is adapted to rotate freely about the vertical axis A₁ of the tensioner spool shaft 80. Bearings may be provided between the tensioner shaft and the tensioner spool. The rotatable tensioner spool 82 desirably includes an outer surface 84 adapted to engage the outer surface of the first drive belt 48 (FIG. 2). The outer surface 84 of the tensioner spool may be smooth. The outer surface 84 of the tensioner spool 82 preferably has a sufficient height to accommodate the various belt positions shown in FIG. 3. In one embodiment, the spring-loaded tensioner 54 preferably includes a locking screw that secures the base 66 of the tensioner 54 to the head stock 22.

In one embodiment, the rotating arm 72 of the spring-loaded tensioner 54 may be rotated in a counter-clockwise direction R₁ (FIG. 4), also referred to as “away”, from the first drive belt for removing tension from the first drive belt so that the positions of one or more of the drive belts may be changed. As the rotatable arm 72 is held “away” by a lock that will be described in more detail below, the internal spring 70 preferably applies a spring force to the rotatable arm 72 for urging the rotatable arm 72 to rotate in a clockwise direction R₂ (FIG. 4) so that the tension spool 82 re-engages the first drive belt. However, at this stage, the lock will prevent the rotatable arm 72 from rotating back into the tension applying position. After an operator has changed the positions of the belts, the lock may be unlocked so that the internal spring 70 is able to rotate the tension arm 72 and the tension spool 82 back into engagement with the first drive belt for re-applying tension to the first drive belt.

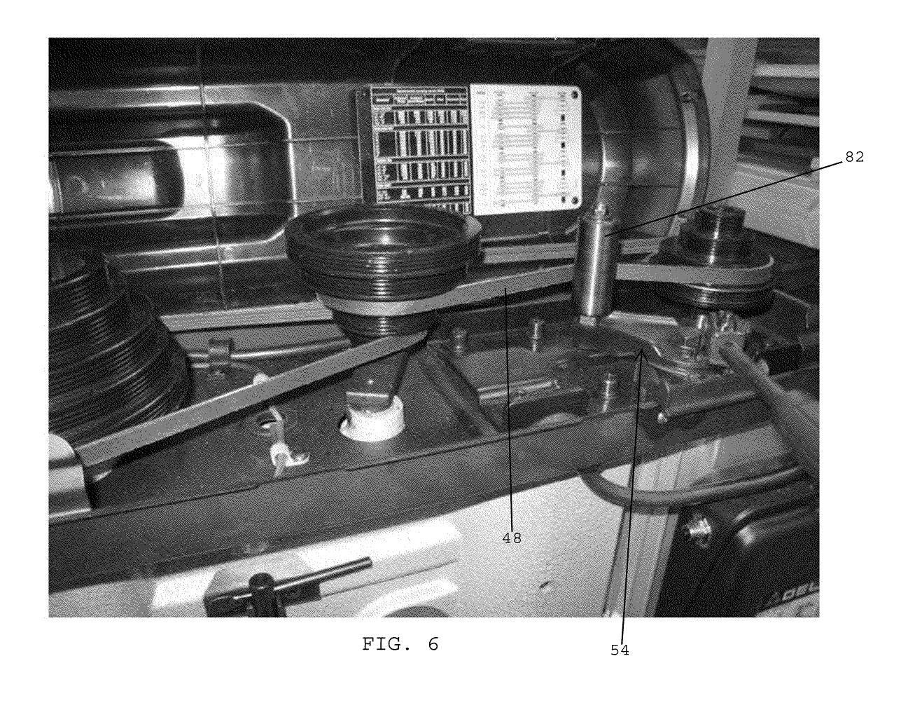

Referring to FIG. 6, in one embodiment, the tension spool 82 is preferably in contact with the outer surface of the first drive belt 48 for applying tension to the first drive belt. The internal spring 70 (FIG. 5) urges the tension spool 82 to remain in contact with the outer surface of the first drive belt 48 for applying a tension force thereto. In one embodiment, the tension force applied by the spring-loaded tensioner 54 through the tension spool 82 is approximately 4-10 pounds and more preferably about 6-8 pounds. In one preferred embodiment, the tension spool 82 preferably engages the slack side of the first drive belt 48.

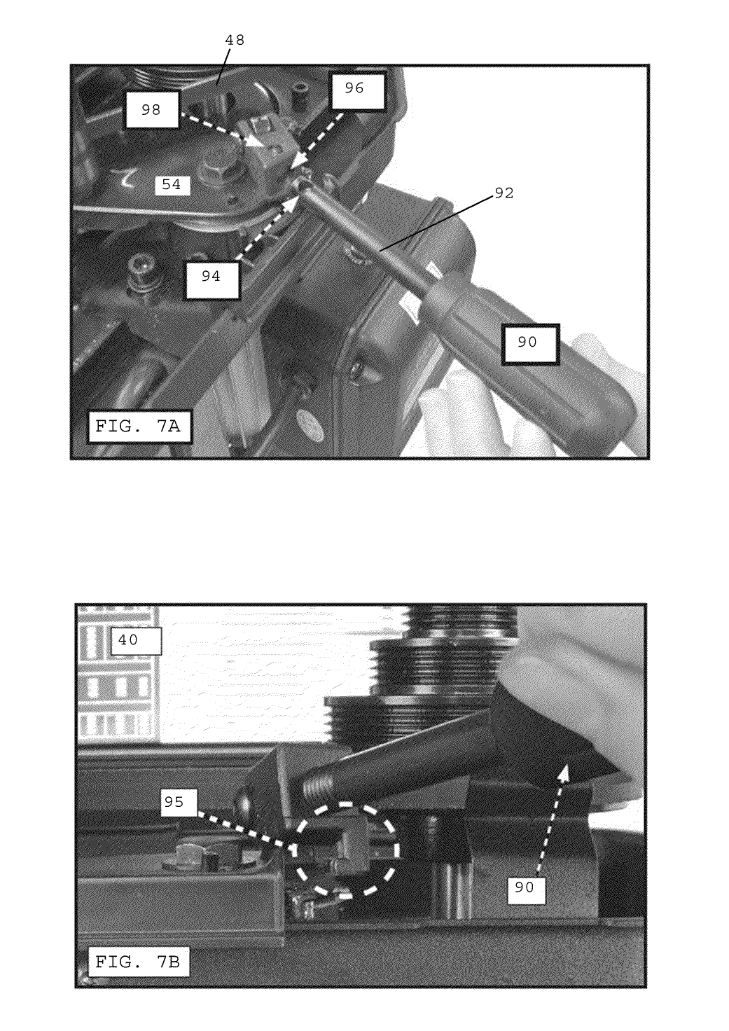

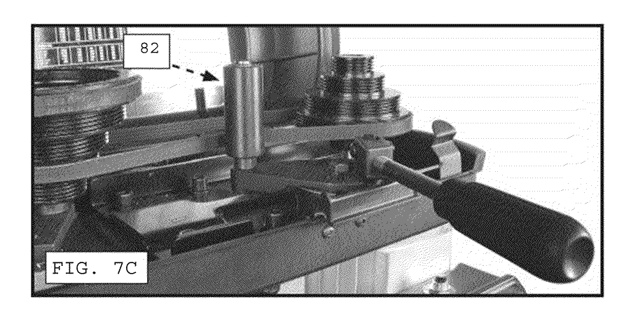

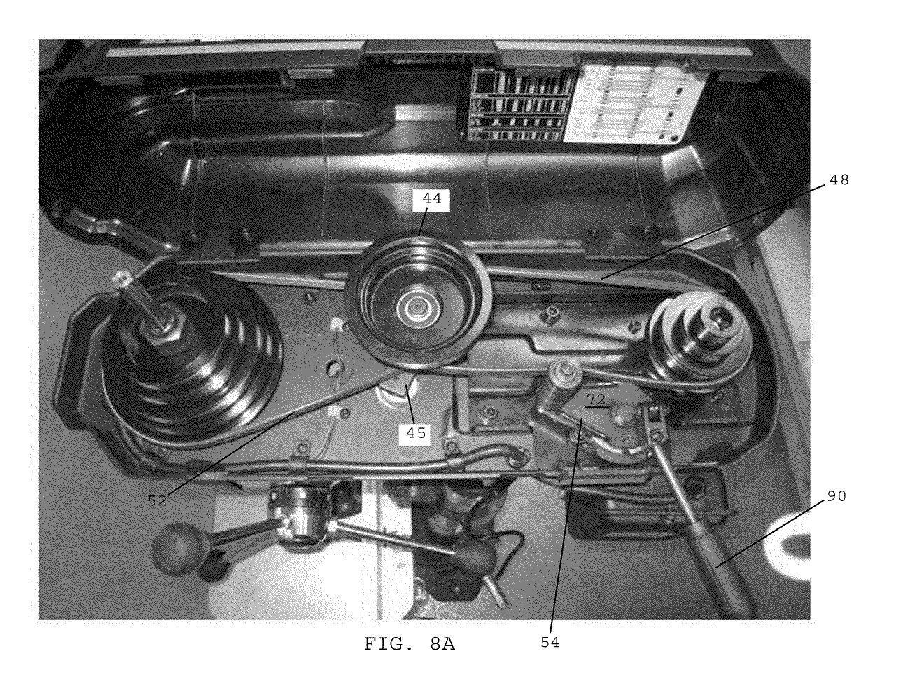

Referring to FIGS. 7A-7C, in one embodiment, a belt tension lever 90 may be used for rotating the spring-loaded drive belt tensioner 54 away from the first drive belt when it is desirable to remove the tension applied to the first drive belt for changing the belt positions on the stepped pulleys. The belt tension lever 90 desirably includes an elongated shaft 92 having a distal end with a hole 94 provided therein. In one embodiment, the spring-loaded tensioner 54 includes a tension adjustment opening 96 that is adapted to receive the distal end of the shaft 92 of the belt tension lever 90. After the distal end of the shaft 92 is inserted into the tension adjustment opening 96, a set screw 98 may be inserted into the hole 94 in the shaft 92 and tightened for locking the belt tension lever 90 to the spring-loaded tensioner 54. When the lever 90 is attached to the tensioner 54, the belt tension lever 90 may be rotated in a counter-clockwise direction for rotating the spring-loaded tensioner 54 away from the first drive belt.

FIGS. 7B and 7C show further steps of a method for changing speeds and adjusting the tension on the drive belts, in accordance with one embodiment of the invention. Referring to FIGS. 7B and 7C, in one embodiment, the head stock pulley cover 40 is lifted to expose the spring-loaded tensioner 54. The belt tension lever 90 is preferably rotated up and to the right so that a lock 95 engages a surface for holding the tensioner arm 72 in the away position. With the tension of the drive belts reduced, an operator may choose the appropriate speed for the drill press by positioning the first and second drive belts on the respective pulleys. An operator may refer to a user manual or the chart shown in FIG. 3 for selecting various drill speeds. In one embodiment, the belts have inner surfaces with v-shaped grooves that preferably match v-shaped projections or grooves provided on the pulleys. After the new position for the drive belts has been selected and the belts re-positioned, the belt tension lever 90 may be lifted for disengaging the lock 95 from the surface so that the tensioner arm 72 may be rotated in a clockwise direction until the tension spool 82 rests against the first drive belt. In one embodiment, the clockwise rotation of the spring-loaded tensioner is limited by a hard stop 112 (FIG. 2) so that the rotatable arm 72 may rotate no further in the clockwise direction.

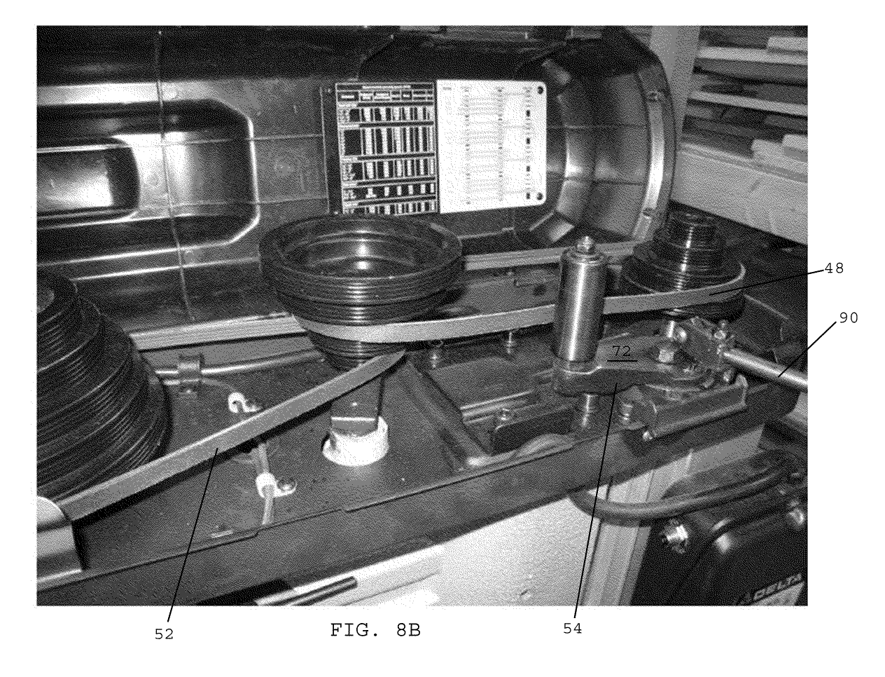

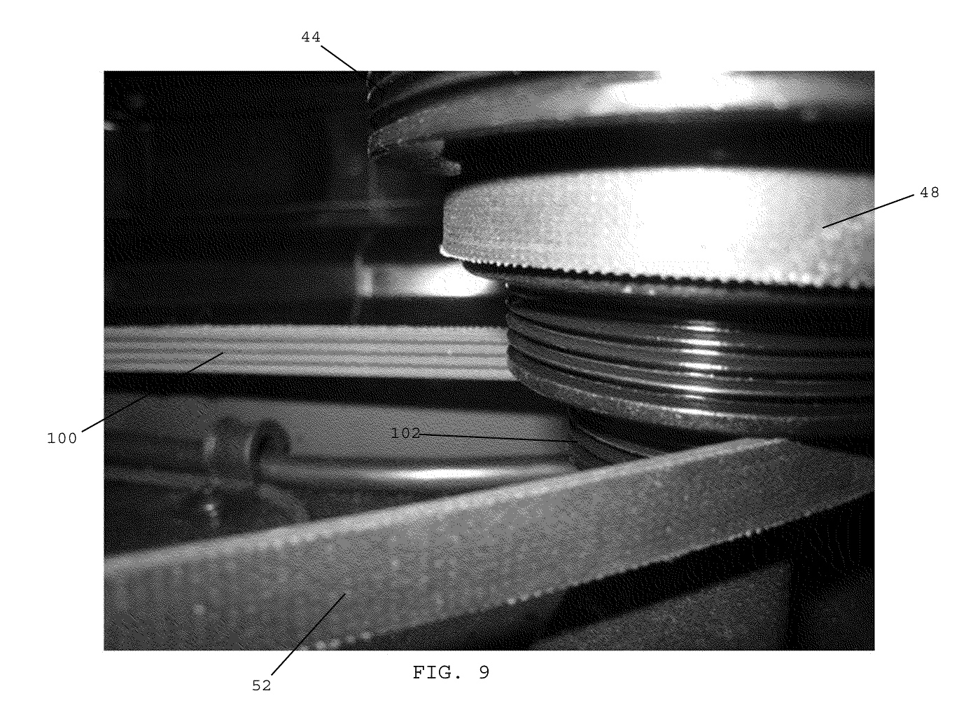

Referring to FIGS. 8A and 8B, in one embodiment, when the spring-loaded tensioner 54 is rotated away from the first drive belt 48 using the belt tension lever 90, the tension on the first drive belt 48 is entirely or substantially removed. At that stage, the rotatable arm 72 is preferably held in the retracted position using the lock 95 (FIG. 7B). With the rotatable arm 72 held in the “away” or locked position, the tension spool 82 applies no or minimal tension to the outer surface and/or slack side of the first drive belt 48. At that stage, an operator may adjust the positions of the first drive belt 48 and the second drive belt 52 as desired for changing the speed of the drive system for the drill press. As part of the belt changing process, an operator may shift the position of the center pulley 44 using the pivoting arm 45 attached to the head stock.

FIG. 9 shows the first drive belt 48 and the second drive belt 52 engaged with different steps on the center pulley 44 shown in FIG. 2. In the particular embodiment shown in FIG. 9, the second drive belt 52 has an inner surface with grooves 100 that mesh with radial grooves 102 on a lower-most step of the center pulley 44. The first drive belt 48 also has internal grooves (not shown) that mesh with the radial grooves (not shown) of a third stepped level of the center pulley 44. As the first drive belt 48 rotates the center pulley 44, the grooves 102 of the lower most step mesh with the internal grooves 100 of the second drive belt 52 for imparting power to the second drive belt, which, in turn, drives the spindle pulley (not shown).

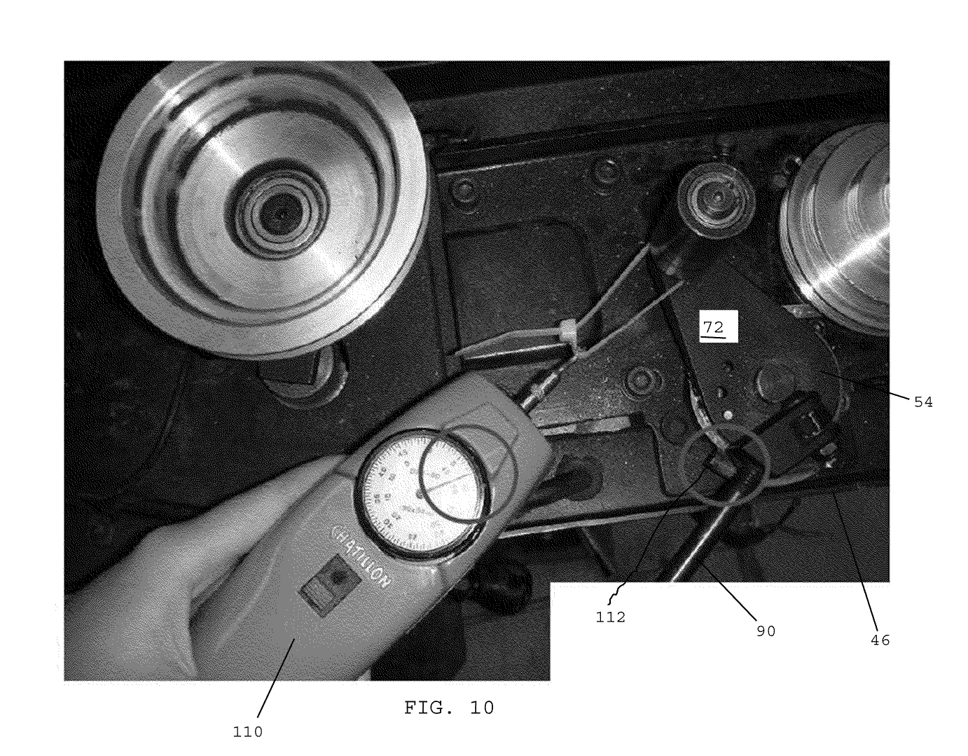

In one embodiment, the level of tension force applied by the spring-loaded tensioner may be established, calibrated, and/or measured to ensure maximum operating efficiency of the system. Referring to FIG. 10, in one embodiment, a strain gauge 110 may be used for measuring the tension level applied by the spring-loaded tensioner 54. In one embodiment, the base 46 of the head stock 20 (FIG. 2) includes a hard stop 112 that is adapted to stop the tensioner arm 72 from rotating further in a clockwise direction. A hook 114 at a distal end of the strain gauge 110 may be coupled with the spring-loaded tensioner 54. The strain gauge may be used to pull the spring-loaded drive belt tensioner until the belt tensioner 54 moves off the hard stop 112. As the strain gauge 110 pulls the spring-loaded tensioner 54 away from the hard stop 112, the internal spring 70 (FIG. 5) within the base of the spring-loaded tensioner 54 preferably urges the arm 72 to move in a counter-clockwise direction. In one embodiment, the preferred reading for the stain gauge is preferably about 4-10 pounds and more preferably about 6-8 pounds. In other embodiments, the range of tension applied by the spring-loaded tensioner may vary depending upon the preferred level of tension that is to be applied to a drive belt of a drive system for power equipment.

In one embodiment, the tension level applied by the spring-loaded tensioner may be measured and/or established using a torque wrench that includes a fixture for coupling the torque wrench with the pivoting arm of the spring-loaded tensioner. The torque wrench may use technology for setting a desired torque level and then using the tool for establishing or measuring a desired torque level.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A drill press comprising:
a motor having a rotatable motor shaft;
a motor pulley mounted on said rotatable motor shaft;
a rotatable spindle and a spindle pulley mounted on said rotatable spindle;
at least one drive belt coupling said motor pulley with said spindle pulley for selectively rotating said rotatable spindle when operating said motor;
a spring-loaded drive belt tensioner adapted to selectively apply a predetermined tension level to said at least one drive belt, wherein said spring-loaded drive belt tensioner has a first position for applying a first level of tension to said at least one drive belt and a second position for applying a second level of tension to said at least one drive belt that is lower than said first level of tension.

2. The drill press as claimed in claim 1, wherein said motor pulley is a stepped motor pulley having a plurality of steps of varying radii and said spindle pulley is a stepped spindle pulley having a plurality of steps of varying radii.

3. The drill press as claimed in claim 2, wherein the position of said at least one drive belt relative to said plurality of steps on said stepped pulleys is changeable for varying the speed of said drill press when said spring-loaded drive belt tensioner is in said second position.

4. The drill press as claimed in claim 1, wherein said spring-loaded drive belt tensioner is extended when in said first position and retracted when in said second position.

5. The drill press as claimed in claim 4, further comprising a lock engageable with said spring-loaded drive belt tensioner for holding said spring-loaded belt tensioner in said second, retracted position.

6. The drill press as claimed in claim 1, wherein said at least one drive belt has an inner surface that is adapted to engage said pulleys and an outer surface, and wherein said spring-loaded drive belt tensioner engages said outer surface of said at least one drive belt when in the first position for applying the first level of tension to said at least one drive belt.

7. The drill press as claimed in claim 6, wherein the first level of tension is between about 4-10 lbs. of tension.

8. The drill press as claimed in claim 7, wherein the second level of tension is between about 0-3 lbs. of tension.

9. The drill press as claimed in claim 1, further comprising:
a center pulley located between said motor pulley and said spindle pulley;
said at least one drive belt including a first drive belt coupling said motor pulley with said center pulley and a second drive belt coupling said center pulley with said spindle pulley, wherein said motor pulley rotates said center pulley through said first drive belt and said center pulley rotates said spindle pulley through said second drive belt.

10. The drill press as claimed in claim 9, wherein said spring-loaded drive belt tensioner is adapted to engage a slack side of said first drive belt when in the first position for applying said first level of tension to said first drive belt.

11. A drill press comprising:
a motor having a rotatable motor shaft and a stepped motor pulley mounted on said rotatable motor shaft;
a rotatable spindle and a stepped spindle pulley mounted on said rotatable spindle, a stepped center pulley located between said stepped motor pulley and said stepped spindle pulley;
a first drive belt connecting said stepped center pulley with said stepped motor pulley;
a second drive belt connecting said stepped spindle pulley with said stepped center pulley;
a spring-loaded drive belt tensioner adapted to apply tension to said first drive belt, wherein said spring-loaded drive belt tensioner has a first position for applying a first level of tension to said first drive belt and a second position for applying a second level of tension to said first drive belt that is less than said first level of tension

12. The drill press as claimed in claim 11, wherein said first drive belt has an inner surface adapted to engage said stepped motor pulley and said stepped center pulley, and said first drive belt having an outer surface facing away from said inner surface, and wherein said spring-loaded drive belt tensioner selectively engages said outer surface of said first drive belt when applying said first level of tension.

13. The drill press as claimed in claim 12, wherein said spring-loaded drive belt tensioner selectively engages a slack side of said first drive belt when applying said second level of tension.

14. The drill press as claimed in claim 12, wherein each of said stepped pulleys has a plurality of steps of varying radii, and wherein when said spring-loaded drive belt tensioner is in said second position the positions of said first and second drive belts relative to said plurality of steps of said stepped pulleys are changeable for varying the speed of said drill press.

15. The drill press as claimed in claim 11, further comprising a head stock containing said motor, wherein said motor is rigidly mounted within said head stock.

16. The drill press as claimed in claim 11, wherein said spring-loaded drive belt tensioner comprises:
a swing arm having a first end pivotally connected to said head stock and a second, free end adapted to swing about said first end;
a freely rotating spool mounted to said second, free end of said swing arm;
a spring in contact with said swing arm for providing a spring force for normally urging said freely rotating spool against said first drive belt when said spring-loaded drive belt tensioner is in said first position.

17. The drill press as claimed in claim 16, further comprising a locking element engageable with said swing arm for holding said spring-loaded drive belt tensioner in said second position and overcoming said spring force.

18. The drill press as claimed in claim 11, wherein said first level of tension is between about 4-10 lbs. of tension, and said second level of tension is between about 0-3 lbs. of tension.

19. The drill press as claimed in claim 11, wherein said first drive belt has an inner surface including a plurality of grooves and said stepped motor and center pulleys have steps with a plurality of projections adapted to mesh with said plurality of grooves on said inner surface of said first drive belt.

20. A variable speed drill press having a spring-loaded drive belt tensioner comprising:
a base;
a support column projecting upwardly from said base along a vertical axis;
a table connected with said support column;
a head stock mounted to an upper end of said support column;
a motor rigidly mounted to said head stock, said motor having a rotatable motor shaft and a stepped motor pulley mounted on said rotatable motor shaft;
a rotatable spindle mounted on said head stock for rotating about an axis that is parallel to said vertical axis of said support column;
a stepped spindle pulley connected to said rotatable spindle,
a stepped center pulley mounted on said head stock and located between said stepped motor pulley and said stepped spindle pulley;
a first drive belt connecting said stepped center pulley with said stepped motor pulley;
a second drive belt connecting said stepped spindle pulley with said stepped center pulley;
a spring-loaded drive belt tensioner adapted to apply tension to an outer surface of said first drive belt on a slack side of said first drive belt, wherein said spring-loaded drive belt tensioner has a first position for applying a first level of tension to said first drive belt and a second position for applying a second level of tension to said first drive belt that is less than the first level of tension, wherein when said spring-loaded drive belt tensioner is in the second position the positions of said first and second drive belts relative to said plurality of steps of said stepped pulleys are changeable for varying the speed of said drill press.
